(19) United States
(12) Patent Application Publication
(10) Pub. No.: US 2007/0061164 A1
(43) Pub. Date: Mar. 15, 2007

(54) HEALTHCARE INFORMATION STORAGE SYSTEM

(75) Inventor: James B. Broselow, Hickory, NC (US)

Correspondence Address: ADAMS EVANS P.A., 301 SOUTH TRYON STREET, SUITE 2180, TWO WACHOVIA CENTER, CHARLOTTE, NC, 28282-1991, US

(73) Assignee: James B. Broselow, Hickory, NC (US)

(21) Appl. No.: 11/307,568

(22) Filed: Feb. 13, 2006

Related U.S. Application Data
(60) Provisional application No. 60/596,315, filed on Sep. 15, 2005.

(51) Int. Cl. G06Q 10/00; G06F 19/00

(52) U.S. Cl. 705/2; 705/3

(57) ABSTRACT

A healthcare information storage system for the capture, storage, and retrieval of healthcare information, including a data input device including an audio input apparatus and video input apparatus for receiving audio and video information captured by the audio input apparatus and video input apparatus, and a data transmitting device for outputting the audio and video information captured by the audio input apparatus and video input apparatus through a first communications link. A data storage device stores the audio and video information received through the first communications link, and at least one data access device receives the audio and video information through a second communications link from the data storage device.

### TECHNICAL FIELD AND BACKGROUND OF THE INVENTION

This invention relates generally to a storage system of patient information and, more particularly, the invention relates to a storage system of audio and video information that is instantly retrievable by a healthcare provider, family member, or patient by way of a data access device.

When a patient is treated by a doctor who is not their regular primary care physician, the patient must alert the doctor of any past medical history, side effects to medicine, and other potentially helpful information which could aid the doctor during treatment. In other situations, such as an emergency, the patient could be unresponsive and unable to communicate any relevant medical history to a healthcare professional. During these crucial moments, it is important for the healthcare professional to be aware of the individual's medical history, and potentially adverse reactions to certain medications. The same is true for a young child or an elderly person who might not be able to communicate with the healthcare professional adequately.

Many individuals wear medical identification bracelets or necklaces that can

alert the healthcare professional of any medical or health conditions, drug and food allergies, prescribed medicines, and emergency contacts. These identifiers are important and helpful, but only provide a limited amount of information in a limited amount of space. For example, if the wearer of an identification bracelet or necklace is currently taking a blood thinner such as Coumadin or Warfarin, this could easily be contained within the space provided. However, if the wearer is also a transplant patient with a stroke risk, the surface area on the bracelet or necklace would not accommodate all of this important information. These identification devices only provide a limited amount of information, and fail to provide any detail or background information about the patient's medical or health condition, allergies, or medications.

In addition, during an office visit or at a hospital, a doctor will convey important information to the patient, such as recommendations, instructions, warnings, or the like. Some procedures require informed consent by the patient, which is conveyed to the doctor enabling him to proceed. However, a written file is usually the only record that specifically notes the information conveyed to the patient, and might contain a note regarding the informed consent. These written files can be illegible, fail to sufficiently state the information conveyed to the patient, and not adequately record the informed consent.

Several solutions for a system of filed patient information has been proposed in the prior art. For example, Wright Publication No. 2002/0046061 discloses a portable storage device that allows healthcare providers to provide patient information on optical disks which are given to the patient. These disks are readable and upgradeable by a patient using a personal computer.

The Rothschild Publication No. 2003/0097351 discloses a portable, personal medical image storage device. This device stores medical history and medical image files that can be carried by a patient or a family member. The device is similar to the size of a keychain. An installer is included in the device which contains viewing software that can be installed on a personal computer. This viewing software allows the addition and removal of files on the device.

Accordingly, it is an object of the invention to provide an extensive database of audio and video information that can be retrievable, with the use of a data access device, by a healthcare professional, family member, or patient to determine any pertinent health information.

### SUMMARY OF THE INVENTION

Therefore, it is an object of the invention to provide a healthcare information storage system of patient information which is easily and instantaneously accessible by a healthcare provider.

It is another object of the invention to provide a healthcare information storage system capable of storing patient information in both audio and video formats.

It is another object of the invention to provide a healthcare information storage system of patient information that can be accessed through a telephone and computer.

It is another object of the invention to provide a healthcare information storage system of patient information that has language translation capabilities.

It is another object of the invention to provide a healthcare information storage system that captures a two-way communication and informed consent by a patient to a healthcare provider.

These and other objects of the present invention are achieved in the preferred embodiments disclosed below by providing a healthcare information storage system for the capture, storage, and retrieval of healthcare information, including a data input device including an audio input apparatus and video input apparatus for receiving audio and video information captured by the audio input apparatus and video input apparatus, and a data transmitting device for outputting the audio and video information captured by the audio input apparatus and video input apparatus through a first communications link. A data storage device stores the audio and video information received through the first communications link, and at least one data access device receives the audio and video information through a second communications link from the data storage device.

According to one embodiment of the invention, the data input device is a computer and telephone.

According to another embodiment of the invention, the data access device is a computer and telephone.

According to another embodiment of the invention, a translation server is interfaced to a third communications link for receiving audio information and translating the audio information into another language.

According to another embodiment of the invention, the information captured and transmitted is a two-way communication and informed consent by a patient to a healthcare professional.

According to another embodiment of the invention, an access control means prevents unauthorized access to the healthcare information.

According to another embodiment of the invention, the information stored is at least one legal document and video information from a patient concerning the legal document.

According to another embodiment of the invention, the information stored is at least one educational video for aiding the healthcare professional.

According to another embodiment of the invention, the information stored is a video of a patient before the onset of a debilitating disease.

According to another embodiment of the invention, the information is accessible by a family member of the patient for reviewing information conveyed during a two-way conversation with a healthcare provider.

According to another embodiment of the invention, a healthcare information storage system is provided for the capture, storage, and retrieval of healthcare information, and includes a data input device including an audio input apparatus and video input apparatus for receiving audio and video healthcare information captured by the audio input apparatus and video input apparatus. A data transmitting device outputs the audio and video information captured by the audio input apparatus and video input apparatus through a first communications link. A data storage device stores the audio and video information received through the first communications link, and a translation device translates the audio information received by the data storage device into a commonly used language. At least one data access device is adapted for receiving the audio and video information through a second communications link from the data storage device by way of a data access device, and an access control means prevents an unauthorized individual from accessing the healthcare information through the data access device.

According to another embodiment of the invention, a method for the capture, storage, and retrieval of healthcare information is provided, the method comprising the steps of providing a data input device, a data transmitting device, a data storage device, and at least one data access device, and receiving audio and video healthcare information captured by an audio input apparatus and video input apparatus into the data input device. Also, the audio and video healthcare information is transmitted by the data transmitting device through a first communications link and the audio and video healthcare information is stored in the data storage device. Lastly, the audio and video information from the at least one data access device is received through a second communications link from the data storage device.

According to another embodiment of the invention, the step of entering healthcare information comprises the step of capturing a two-way communication and informed consent of a patient to a healthcare professional.

According to another embodiment of the invention, the step of receiving audio and video information comprises the step of gaining access to the healthcare information by using an access control means allowing only predetermined individuals access to the health information.

### BRIEF DESCRIPTION OF THE FIGURES

Some of the objects of the invention have been set forth above. Other objects and advantages of the invention will appear as the invention proceeds when taken in conjunction with the following drawings, in which:

FIG. 1 is a flow diagram of a healthcare information storage system;

FIG. 2 is a flow diagram of the healthcare information storage system with language translation capabilities; and

FIG. 3 is a flow diagram of the use of an access control means to retrieve medical information from the healthcare information storage system.

### DESCRIPTION OF THE PREFERRED EMBODIMENT AND BEST MODE

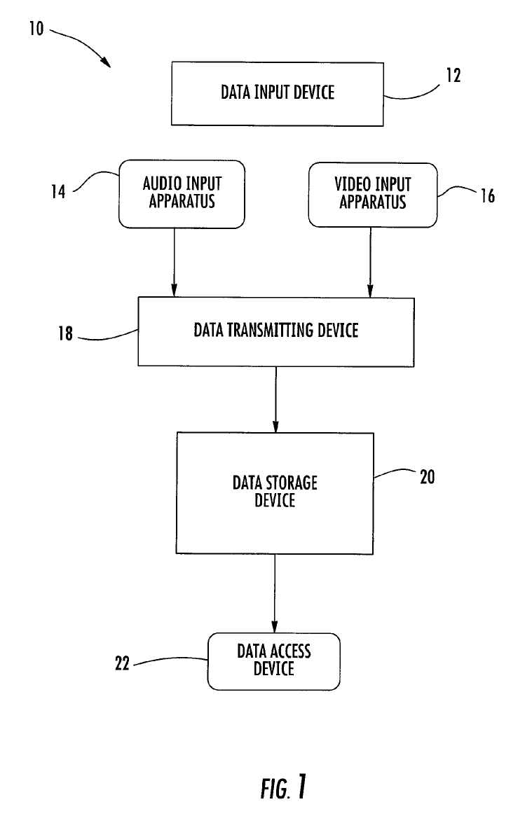

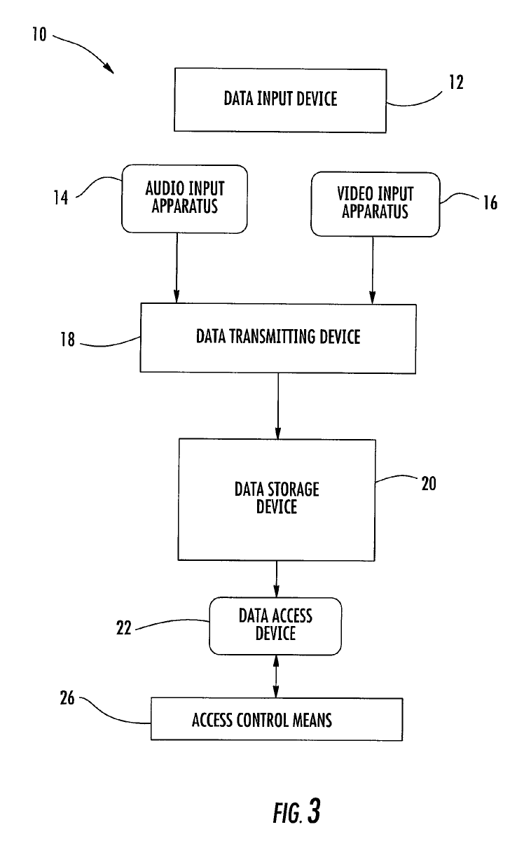

Referring now specifically to the drawings, an exemplary audio and video healthcare database system is illustrated, in the form of flow charts, in FIGS. 1-3 and is shown generally at reference numeral 10. A patient, healthcare provider, friend, or relative supplies healthcare information to a data input device 12 that has an audio input apparatus 14 and video input apparatus 16. The healthcare information is transmitted by a data transmitting device 18 to a data storage device 20, such as a system server, and stored as a patient file. The audio input apparatus 14 and video input apparatus 16 may be a telephone and computer, respectively, utilizing a microphone, web cam, video camera, or other similar device. The healthcare information is transmitted through a first communications link interfaced to the data storage device 20.

Preferably, the data transmitting device 18 utilizes conventional phone lines or an Internet connection. However, other types of links can be used, including a broadband telephone link, cellular telephone link, satellite link, data telephone link, radio-frequency link, intranetwork link, serial link, infrared link, fiber optic link, or coaxial cable link to communicate with the data storage device 20.

The patient's files are centrally stored within the data storage device 20 that is designed to store a plurality of data, audio, and video files. The files are stored under patient specific information, for example, an identification number, first letter of the last name, and/or full name to provide instantaneous access. The files are dated at the time of the entry and sorted in chronological order. Contemporary information, such as a news headline, can also be included to substantiate the entry date.

The data storage device 20 is preferably a high-capacity storage medium configured to organize data, audio, and video files, and provide storage and access to the files. The data storage device 20 can have storage capabilities in the form of volatile storage, non-volatile storage, removable storage, fixed storage, random access storage, or preferably, a set of hard drives. The data storage device 20 is physically located at a secure site having an emergency power backup in order to receive, retrieve, and provide data continuously without interruption.

The healthcare professional, family member, or patient can retrieve a patient's health information from the data storage device 20 by way of a data access device 22, such as a computer and telephone. The data access device 22 communicates with the data storage device 20 through a communications link interfaced to the data storage device 20. Preferably, data access device 22 uses conventional phone lines or an Internet connection to access the health information stored in the data storage device 20. However, other types of links can be used, including a broadband telephone link, cellular telephone link, satellite link, data telephone link, radio-frequency link, intranetwork link, serial link, infrared link, fiber optic link, or coaxial cable link to communicate with the data storage device 20.

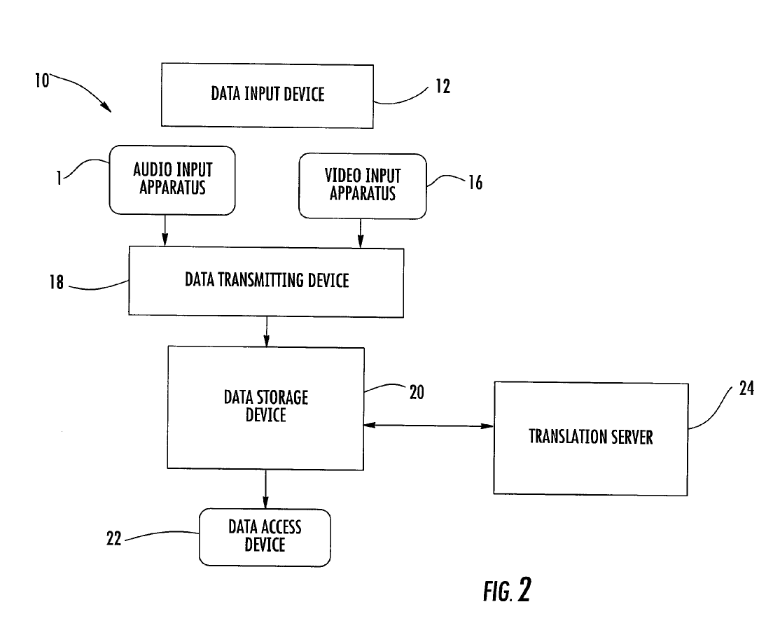

If required by the healthcare professional, the audio and video health information files can be transferred to a translation server 24 with language translation capabilities, as shown in FIG. 2. The healthcare professional determines whether a translation is needed, then, transfers the audio file to the translation server 24 for translation. In the case of video files, the audio is first stripped from the video file, then, transferred to the translation server 24. Once translated, the audio files are rerouted to the data storage device 20 where they are stored until needed, and the video files are recombined with the audio counterpart.

The storage system 10 also includes certain safeguards to protect the privacy of an individuals medical records, as required by the Health Insurance Portability and Accountability Act. The data storage device 20 is a secure system that allows only specified individuals to access the healthcare information. Ideally, the health information is accessed using an access control means 26, such as a patient's confidential identification number. The access control means 26 may allow access by manually typing the identification number into the data access device 22. However, scanning techniques can also be utilized to allow a healthcare professional to scan a bar code containing the identification number located on a piece of jewelry or a microchip implanted under the skin. Further, the access control means 26 may include a biometric system that can be used to scan the patient's finger, eye, or other individualized bodily feature to gain access to the patient's files.

In addition, a will, living will, power of attorney, or other legal document may be stored on the data storage device 20 for access by a healthcare professional, attorney, or other interested individual. These documents are typically in written form; therefore, they can easily be stored in a document file in the data storage device 20. A video file expressing the patient's wishes and desires can also be stored in the data storage device 20. Preferably, the video file will document the individual verbally expressing his intent, which is contained in the stored document. This video file can be used in the future to determine the patient's mental capacity, and intent at the time of executing the will or other legally binding document.

In another embodiment of the invention, the healthcare professional supplies information to a data input device 12 regarding instructions or warnings given to the patient during an office visit, including the patient's response. Typically, an audio or video file of instructions or specific warnings are recorded and stored in the data storage device 20, making a “living” patient file. This provides critical patient specific information for acute treatment and specialized information, such as specialized health needs, unusual medical equipment, or special dosage requirements. This video file provides further documentation other than what is typically contained in the doctor's written or typed notes. Permission given by the patient to the healthcare professional may also be stored in audio and video form for insertion into the patient file, which is stored in the data storage device 20.

The “living” patient file may also be accessed by a family member who is acting as a patient's surrogate. For example, the child of an elderly patient may wish to review the audio and video information of their parent's visit to the doctor in order to help the parent understand the salient medical issues, to make sure the parent understands what the doctor expects, the date, time, and name of the doctor for future appointments, and changes in medication.

In another embodiment of the invention, video files stored in the data storage device 20 provide educational videos to aid the healthcare professional. For instance, a video setting forth the procedure to replace a blocked tracheal tube could be contained on the data storage device 20 and instantly accessible from a data access device 22. This information could be generic, or patient specific. In elderly patients, video footage could substantiate a patient's baseline physical and mental status, aiding decisions related to resuscitation, end of life procedures, or lending assistance with the prognoses for hip replacement surgery. This video would serve as a surrogate until a family member arrives to help with these challenging decisions.

In another embodiment, the video files can be used to aid an Alzheimer's patient and his treating physician. A video of the patient, before the onset of Alzheimer's or shortly thereafter, can be taken and stored on the data storage device 20. This video can be accessed by the physician to assist with medical care.

A healthcare information storage system is described above. Various details of the invention may be changed without departing from its scope. Furthermore, the foregoing description of the preferred embodiments of the invention and the best mode for practicing the invention are provided for the purpose of illustration only and not for the purpose of limitation—the invention being defined by the claims.

What is claimed is:

1. A healthcare information storage system for the capture, storage, and retrieval of healthcare information, the system comprising:
(a) a data input device including an audio input apparatus and video input apparatus for receiving audio and video information captured by the audio input apparatus and video input apparatus;
(b) a data transmitting device for outputting the audio and video information captured by the audio input apparatus and video input apparatus through a first communications link;
(c) a data storage device for storing the audio and video information received through the first communications link; and
(d) at least one data access device for receiving the audio and video information through a second communications link from the data storage device.

2. A healthcare information storage system according to claim 1, wherein the data input device is a computer and telephone.

3. A healthcare information storage system according to claim 1, wherein the data access device is a computer and telephone.

4. A healthcare information storage system according to claim 1, wherein a translation server is interfaced to a third communications link for receiving audio information and translating the audio information into another language.

5. A healthcare information storage system according to claim 1, wherein the information captured and transmitted is a two-way communication and informed consent by a patient to a healthcare professional.

6. A healthcare information storage system according to claim 1, wherein an access control means prevents unauthorized access to the healthcare information.

7. A healthcare information storage system according to claim 1, wherein the information stored is at least one legal document and video information from a patient concerning the legal document.

8. A healthcare information storage system according to claim 1, wherein the information stored is at least one educational video for aiding the healthcare professional.

9. A healthcare information storage system according to claim 1, wherein the information stored is a video of a patient before the onset of a debilitating disease.

10. A healthcare information storage system according to claim 1, wherein the information is accessible by a family member of the patient for reviewing information conveyed during a two-way conversation with a healthcare provider.

11. A healthcare information storage system for the capture, storage, and retrieval of healthcare information, the system comprising:
(a) a data input device including an audio input apparatus and video input apparatus for receiving audio and video healthcare information captured by the audio input apparatus and video input apparatus;
(b) a data transmitting device for outputting the audio and video information captured by the audio input apparatus and video input apparatus through a first communications link;
(c) a data storage device for storing the audio and video information received through the first communications link;
(d) a translation device for translating the audio information received by the data storage device into a commonly used language;
(e) at least one data access device adapted for receiving the audio and video information through a second communications link from the data storage device by way of a data access device; and
(f) an access control means for preventing an unauthorized individual from accessing the healthcare information through the data access device.

12. A healthcare information storage system according to claim 11, wherein the data input device is a computer and telephone.

13. A healthcare information storage system according to claim 11, wherein the data access device is a computer and telephone.

14. A healthcare information storage system according to claim 11, wherein the information captured and transmitted is a two-way communication and informed consent by a patient to a healthcare professional.

15. A healthcare information storage system according to claim 11, wherein the information stored is at least one legal document and video information from a patient concerning the legal document.

16. A healthcare information storage system according to claim 11, wherein the information stored is at least one educational video for aiding the healthcare professional.

17. A healthcare information storage system according to claim 11, wherein the information stored is a video of a patient before the onset of a debilitating disease.

18. A method for the capture, storage, and retrieval of healthcare information, the method comprising the steps of:
(a) providing a data input device, a data transmitting device, a data storage device, and at least one data access device;
(b) receiving audio and video healthcare information captured by an audio input apparatus and video input apparatus into the data input device;
(c) transmitting the audio and video healthcare information by the data transmitting device through a first communications link;
(d) storing the audio and video healthcare information in the data storage device; and
(e) receiving the audio and video information from the at least one data access device through a second communications link from the data storage device.

19. A method according to claim 18, wherein the step of entering healthcare information comprises the step of capturing a two-way communication and informed consent of a patient to a healthcare professional.

20. A method according to claim 18, wherein the step of receiving audio and video information comprises the step of gaining access to the healthcare information by using an access control means allowing only predetermined individuals access to the health information.
